(19) United States
(12) Patent Application Publication
(10) Pub. No.: US 2026/0276073 A1
(43) Pub. Date: Sep. 17, 2026

(54) Transmission Having a Displacement Body for a Drivetrain

(71) Applicant: Bayerische Motoren Werke Aktiengesellschaft, Muenchen (DE)

(72) Inventor: Andreas Wagner, St. Valentin (AT)

(21) Appl. No.: 19/167,584

(22) PCT Filed: Apr. 3, 2024
(86) PCT No.: PCT/EP2024/059016

§ 371 Date: Sep. 22, 2025

(30) Foreign Application Priority Data
May 2, 2023 (DE) 10 2023 111 187.6

(51) Int. Cl. F16H 57/04

(52) U.S. Cl. CPC F16H 57/0423; F16H 57/0436; F16H 57/0457

(57) ABSTRACT

A system and method for providing a proactive message on a display of a vehicle is disclosed herein. The method includes providing a representation of a digital voice assistant of the vehicle on a display in a field of view of a user of the vehicle. The proactive message is determined by the digital voice assistant of the vehicle, and the representation of the digital voice assistant of the vehicle is adapted depending on the proactive message on the vehicle's display. The method further includes detecting a line of sight of the user of the vehicle towards the adapted representation of the digital voice assistant by an interior camera of the vehicle, and activating a voice recognition system of the digital voice assistant after detection of the line of sight of the user of the vehicle towards the adapted representation of the digital voice assistant on the vehicle's display. A voice message from the user of the vehicle is received by the voice recognition system of the digital voice assistant of the vehicle, and the proactive message is provided on the vehicle's display depending on the voice message received from the user of the vehicle.

### CROSS-REFERENCE TO RELATED APPLICATIONS

The present application is the U.S. national phase of PCT Application PCT/EP 2024/059016 filed on Apr. 3, 2024, which claims priority of German patent application No. 10 2023 111 187.6 filed on May 2, 2023, the entire contents of which are incorporated by reference herein.

### FIELD

The disclosure relates to a transmission for a drivetrain of a motor vehicle. More specifically, the disclosure relates to a transmission comprising a transmission housing, at least two drive elements, which are in engagement with one another and are accommodated in a housing interior of the transmission housing, at least one displacement body, which is designed to displace lubricant which is accommodated in the housing interior and is used for lubricating the at least two drive elements, and a lubricant exchange opening, via which the lubricant can be exchanged between the housing interior and a peripheral region surrounding the housing interior.

### BACKGROUND

Displacement bodies of this kind are used to reduce a quantity lubricant that has to be carried in the transmission, wherein the displacement makes it possible to achieve a high lubricant filling level within the transmission, even when the quantities of lubricant are small. Thus, DE 10 2010 010 816 A1, for example, shows a gearbox comprising at least functional parts and a gear housing, wherein a displacement body is arranged between the functional parts and the gear housing and is embodied as a hollow body.

EP 1 389 697 A2 discloses a transmission for a motor vehicle which comprises at least one wheel set for power transmission and a housing, in which the wheel set is mounted, and which contains a lubricating fluid for the wheel set and a gas, wherein the nominal quantity of lubricant in the housing is chosen in such a way that at least one lower wheel of the wheel set is immersed in the lubricant, even under unfavorable operating conditions. Arranged in the housing is a displacement body for the lubricant, which is immersed at least predominantly in the lubricant. Here, the displacement body is a part of a housing cover which faces into the housing interior.

It would be advantageous to further develop a transmission having a displacement body and a motor vehicle of the type stated at the outset in such a way that improved lubricant movement is made possible.

### SUMMARY

At least one embodiment of the disclosure relates to a transmission for a drivetrain of motor vehicle, comprising a transmission housing, at least two drive elements, which are in engagement with one another and are accommodated in a housing interior of the transmission housing, at least one displacement body, which is designed to displace lubricant which is accommodated in the housing interior and is used for lubricating the at least two drive elements, and a lubricant exchange opening, via which the lubricant can be exchanged between the housing interior and peripheral region surrounding the housing interior. The drive elements can preferably be elements for torque transmission, e.g. gearwheels, which are in engagement with one another.

According to the disclosure, it is envisaged that the at least one displacement body has at least one lubricant-guiding region, which is designed to guide the lubricant, at least in some region or regions, along the displacement body and within the housing interior to the lubricant exchange opening. This is advantageous since the displacement body enables the lubricant contained in the housing interior, generally in the form of transmission oil, to be selectively displaced and thereby enables the lubricant to reach machine elements, possibly including the drive elements, to be lubricated and/or to be cooled by means of the lubricant, even when the housing interior contains little lubricant. In this case, the lubricant-guiding region enables selective, low-resistance and active extraction of the lubricant, e.g. by means of a lubricant pump, without the lubricant exchange opening being constricted or blocked by the displacement body during extraction. This improves lubricant movement of the lubricant during exchange via the lubricant exchange opening. The lubricant-guiding region can preferably be designed to guide the lubricant along a number of different spatial directions, which may be perpendicular to one another for example, and this is made possible, for example, by the fact that the lubricant-guiding region can have lubricant passages that are oriented at an angle to one another and are interconnected. These lubricant passages can be designed, for example, as respective through openings for guiding the lubricant or as respective grooves for guiding the lubricant. As a particular preference, the lubricant-guiding region can be open in the direction of the housing interior, thus enabling the lubricant to be discharged from the housing interior or introduced into the latter unhindered via the lubricant-guiding region and the lubricant exchange opening.

The disclosed embodiments are based on the insight that large volumes of air are present in the corresponding housing interiors in conventional transmissions for vehicles, especially in the case of transmissions which are designed to be driven by electric motors as drive motors. In the case of conventional systems, large quantities of lubricant are therefore necessary, and these are introduced into the housing interior in order to supply lubricant to machine elements to be lubricated and/or cooled.

On the one hand, the use of the displacement body with its lubricant-guiding region makes it possible to displace lubricant within the housing interior to such machine elements, even when the quantities of lubricant in the housing interior are small and, on the other hand, allows reliable exchange of the lubricant with improved lubricant movement by virtue of the lubricant-guiding region.

To make it possible to ensure sufficient cooling of a transmission cooled by lubricant, in particular oil, which, for example, may be assigned to an electric machine of a drivetrain of motor vehicle, it is advantageous to provide a sufficient volume flow of the lubricant, e.g. at a main snorkel of a lubricant pump, which can preferably be designed as a pressure pump, in particular as a hydraulic oil pump. In sporty electric machines (E-machines for short), also referred to as electric motors, this can preferably be achieved by means of active lubricant suction pumps, which actively extract lubricant from defined regions of the E-machine during dynamic driving maneuvers (dynamic transverse/longitudinal movements, i.e. high transverse and/or longitudinal acceleration) of the motor vehicle, wherein the lubricant can be fed in again close to the main snorkel.

The basic principle of the disclosure resides in the reduction of an air volume by means of displacement bodies in the transmission region, which are intended to reduce the lubricant volume in the transmission, i.e. in the housing interior of the transmission. In this way, the potentially available volume for lubricant accumulations (oil accumulations) within this region of the E-machine is reduced. With a displacement body arranged in the housing interior, this leads, particularly during dynamic transverse movements, to a significantly better lubricant availability at an active extraction point of the transmission owing to avoidance, at least to a large extent, of dead air volumes. One advantage of the disclosure herein is a reduction in the lubricant volume and an associated cost and weight saving in one or more E-machines while optimizing the lubricant supply at the active extraction points using the principle of volume displacement by packing bodies.

In one advantageous further development of the disclosure, the at least one displacement body is different from a machine element. This advantageously enables the displacement body to be configured in a manner that is particularly optimized in terms of weight. The displacement body can thus be freed from the tasks of torque transmission, fastening, mounting, support and/or housing functions within the housing interior. For example, the displacement body therefore does not need to provide support for a transmission shaft or for some other machine element and does not need to make any contribution to torque transmission by engagement in a tooth system, to mention just a few examples. The expression “machine element” should be understood to refer, for example, to axles, shafts, bearings, gearwheels, shift elements (such as clutch elements or claws), and fastening elements such as screws.

In another advantageous further development of the disclosure, the displacement body occupies at least 20%, preferably at least 40% and particularly preferably at least 60% of the housing interior. This is advantageous since it enables the displacement body to be dimensioned in a manner that is particularly appropriate to requirements. The larger this percentage of the housing interior occupied by the displacement body, the more reliable is the lubricant supplied to machine elements, e. g. the drive elements of the transmission, even in the case of high longitudinal and transverse accelerations while the motor vehicle is being driven. In the case of low longitudinal and transverse accelerations, on the other hand, it may be sufficient for the displacement body to occupy just a small proportion, e. g. between 20% and 40% of the housing interior, and therefore the displacement body can be of correspondingly smaller dimensions, and weight can be saved. In total, therefore, the displacement body can occupy 20%, 25%, 30%, 35%, 40%, 45%, 50%, 55% or 60% of the housing interior, for example.

In another advantageous further development of the disclosure, the displacement body surrounds at least some region or regions of one of the drive elements. This is advantageous since it enables the displacement body to occupy a particularly large proportion of the housing interior and/or enables the lubricant to be guided to locations to be lubricated, e.g. tooth systems or bearing locations, by means of the displacement body in a manner that is particularly appropriate to requirements and particularly targeted. In this case, the displacement body can preferably be arranged, at least in some region or regions, between the outer circumference of at least one of the drive elements and a housing region of the transmission housing which is closest to the outer circumference.

The displacement body can preferably surround, at least predominantly, preferably completely, at least one of the drive elements at the circumference. In the present case, the expression “surround predominantly at the circumference” should be understood to mean that the displacement body surrounds more than 50% of the circumference of the corresponding drive element at the circumference. If, for example, the drive element is designed as a shaft or as a gearwheel, the displacement body can preferably extend along such a drive element over more than a center angle of 180°, that is to say, for example, 181° or more, at an axis of rotation of the drive element.

In another advantageous further development of the disclosure, the transmission comprises at least one additional displacement body, which is different from the displacement body and surrounds at least some region or regions of at least one of the drive elements and likewise of the displacement body. It is advantageous here that the displacement body and the additional displacement body can together almost completely surround the at least one drive element, with the result that the displacement body and the additional displacement body together occupy a particularly high proportion of the housing interior. The required lubricant volume in the housing interior can also be correspondingly small.

In another advantageous further development of the disclosure, the displacement body and/or the additional displacement body comprise/comprises at least one recess for the insertion of (i.e., configured to receive) at least some region or regions of at least one of the drive elements. This is advantageous since the displacement body and/or the additional displacement body can thereby almost completely surround the corresponding drive element because the displacement body can extend along the circumference of the drive element over a center angle of 360° relative to the axis of rotation of the drive element. This can be achieved, for example, if the displacement body has a cylindrical recess into which, for example, a drive element designed as a gearwheel is introduced and is thereby surrounded at the circumference. A gap, by which circulation of the lubricant within the housing interior is improved, can preferably be provided between the displacement body and the additional displacement body.

In another advantageous further development of the disclosure, the lubricant-guiding region comprises a through opening for guiding the lubricant and/or a groove for guiding the lubricant. This is advantageous since the lubricant can be guided selectively to the lubricant exchange opening with little flow resistance. For this purpose, as a particularly preferred option, the through opening and the lubricant exchange opening can overlap.

In another advantageous further development of the disclosure, the displacement body is formed from a nonmetallic material, in particular plastic. This is advantageous since it enables the displacement body to be made particularly light.

In another advantageous further development of the disclosure, the transmission comprises a lubricant pump, which is connected to the lubricant exchange opening in order to extract lubricant from the housing interior. This is advantageous since selective extraction of the lubricant from the housing interior can be performed by means of the lubricant pump. By means of the displacement body, it is possible to form lubricating gap regions between the displacement body and a housing wall of the transmission housing, in which it is possible to achieve a high flow rate of the lubricant by extraction of the lubricant, and this can lead, for example, to a high heat transfer coefficient at the housing wall and/or can promote improved removal of any contaminants, e.g. abraded material. The lubricant pump can preferably be designed as a lubricant suction pump.

At least one additional embodiment of the disclosure relates to a motor vehicle having a drivetrain that comprises a drive motor coupled to a transmission, wherein the transmission is configured to be driven by means of the drive motor. In this motor vehicle, improved lubricant movement with a lower quantity of lubricant to be carried is made possible. The drive motor can be an electric motor. In principle, however, embodiment of the drive motor is an internal combustion engine is also conceivable.

The preferred embodiments presented in relation to one of the aspects and the advantages thereof apply correspondingly to the other aspects of the disclosure in each case and vice versa.

The features and combinations of features mentioned above in the description as well as the features and description of the figures and/or shown in the figures alone can be used not only the respectively indicated combination but also in other combinations or in isolation without exceeding the scope of the disclosure.

Further advantages, features and details of the disclosure will become apparent from the claims, the following description of preferred embodiments and with reference to the drawings.

### BRIEF DESCRIPTION OF THE DRAWINGS

The disclosure herein is explained again below by means of a specific exemplary embodiment. In this regard:

FIG. 1 shows an abstracted illustration of a motor vehicle and the drivetrain thereof, which has a drive motor and a transmission (shown schematically) to be driven by means of the drive motor; and

FIG. 2 shows an enlarged illustration of a region A delineated in FIG. 1.

### DESCRIPTION

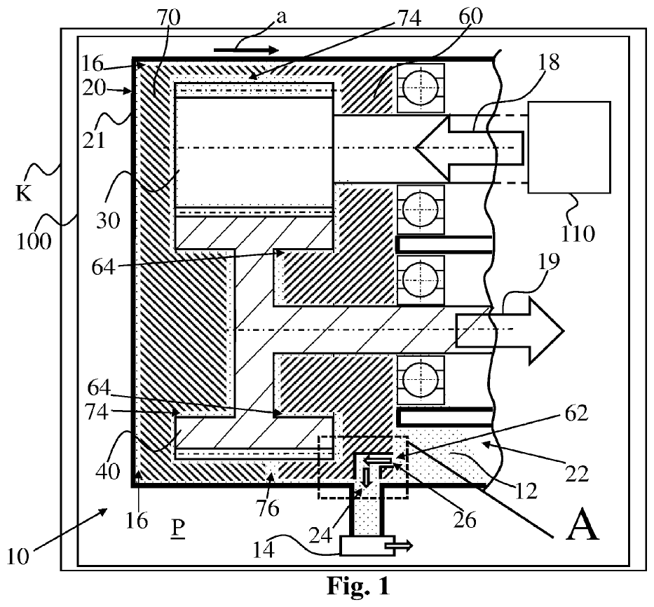

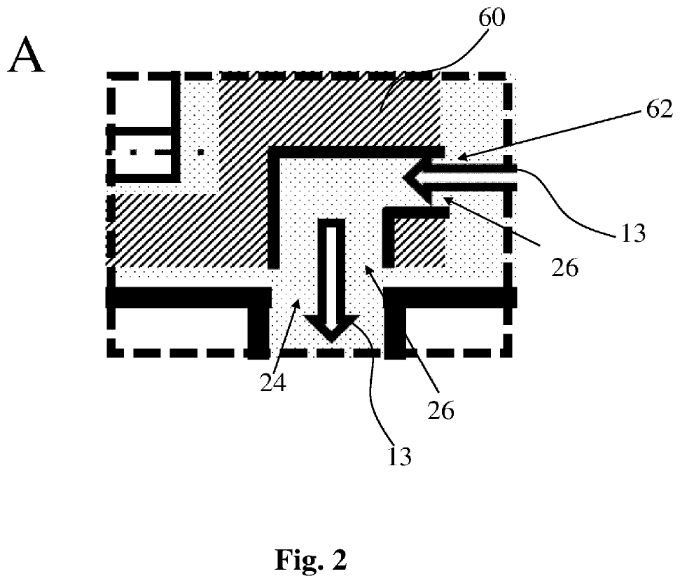

FIG. 1 shows schematically a motor vehicle K having a drivetrain 100, which comprises a drive motor 110 and a transmission 10 to be driven by means of the drive motor 110. FIG. 2 shows an enlarged illustration of a sub-region A delimited in FIG. 1. In the present case, the drive motor 110 is designed as an electric drive machine and is connected for torque transmission to the transmission 10. Respective arrows in FIG. 1 indicate a drive input 18 and a drive output 19.

The transmission 10 comprises a transmission housing 20 having a housing wall 21, drive elements 30, 40, which are in engagement with one another and are accommodated in a housing interior 22 of the transmission housing 20, a displacement body 60 and an additional displacement body 70, which are designed to displace lubricant 12 which is held in the housing interior 22 and used to lubricate the drive elements. In addition, a lubricant exchange opening 24 is provided, via which the lubricant 12 can be exchanged between the housing interior 22 and a peripheral region P surrounding the housing interior 22. The displacement body 60 has at least one lubricant-guiding region 62, which is designed to guide the lubricant 12, at least in some region or regions, along the displacement body 60 and within the housing interior 22 to the lubricant exchange opening 24.

In addition to the displacement body 60, an additional displacement body 70 is likewise provided. Both the displacement body 60 and the additional displacement body 70 are different from a machine element and can each be formed from a nonmetallic material. In the variant of the transmission 10 under consideration, the displacement body 60 and the additional displacement body 70 are formed from a plastic. By means of the displacement body 60 and the additional displacement body 70, respective lubricating gap regions 16 are formed between the displacement body and the housing wall 21 of the transmission housing 20. The displacement body 60 and the additional displacement body 70 displace the lubricant contained in the housing interior 22, and therefore a high lubricant level is established even when the quantity of lubricant contained in the housing interior 22 is small. Moreover, the displacement ensures that sufficient lubricant gets to respective machine elements to be lubricated, e.g. the drive elements 30, 40 or respective rolling bearings of the transmission 10, even in the case of high values of an acceleration a that occurs while the motor vehicle K is being driven, this being indicated in FIG. 1 by an arrow. The acceleration a can be a longitudinal acceleration and/or a transverse acceleration.

The displacement body 60 and the additional displacement body 70 different from the displacement body 60 can jointly occupy at least 20%, preferably at least 40% and particularly preferably at least 60% of the housing interior 22. In the present case, the remaining parts of the housing interior are occupied by the drive elements 30, 40, in the present case designed as gearwheels, and other machine elements, e.g. rolling bearings, as shown schematically in FIG. 1.

The displacement body 60 and the additional displacement body 70 surround the two drive elements 30, 40, in each case in some region or regions. For this purpose, the displacement body 60 and the additional displacement body 70 comprise respective recesses 64, 74 for the insertion of at least some region or regions of at least one of the drive elements 30, 40. The recesses 64, 74 can be cylindrical, at least in some region or regions, or hollow-cylindrical, at least in some region or regions, for example, as a result of which it is possible, in the region of the tooth system of the drive elements 30, 40, which are designed as gearwheels in the present case, to form a lubricating gap which is uniformly wide, at least in some region or regions, running around along the tooth system. This enables lubricant distribution which is homogeneous, at least in some region or regions, over the outer circumference of the drive elements 30, 40. In this case, the displacement body 60 and the additional displacement body 70 can surround the drive elements 30, 40 from mutually opposite directions and thus on different sides. As a result, on the one hand, the respective drive elements 30, 40 can be situated between the displacement body 60 and the additional displacement body 70 and, on the other hand, a gap 76 can remain between the displacement body 60 and the additional displacement body 70, as can be seen from FIG. 1. The gap 76 ensures that the lubricant gets to the drive elements 30, 40 and can flow away from these drive elements 30, 40 again. Lubricant exchange is thus ensured directly at the drive elements 30, 40.

The lubricant-guiding region 62 comprises at least one through opening 26 for guiding the lubricant 12 and additionally or alternatively a groove (not shown specifically) for guiding the lubricant 12. In the present case, the through opening 26 is formed by passages oriented at an angle, in particular a right angle, to one another, which extend through the displacement body 60.

In order to discharge the lubricant from the housing interior 22 via the lubricant-guiding region 62, the transmission 10 comprises a lubricant pump 14, which is connected to the lubricant exchange opening 24 in order to extract lubricant 12 from the housing interior 22. The lubricant exchange opening forms an extraction point from the transmission 10, wherein active lubricant extraction (in this case: oil extraction) can take place at the extraction point by means of the lubricant pump 14. Extraction by means of the lubricant pump 14 leads to a lubricant volume flow 13 which is indicated by respective arrows in FIG. 2.

### LIST OF REFERENCE SIGNS

10 transmission
12 lubricant
13 lubricant volume flow
14 lubricant pump
16 lubricating gap region
18 drive input
19 drive output
20 transmission housing
21 housing wall
22 housing interior
24 lubricant exchange opening
26 through opening
30 drive element
40 drive element
60 displacement body
62 lubricant-guiding region
64 recess
70 additional displacement body
74 recess
76 gap
100 drivetrain
110 drive motor
K motor vehicle
P peripheral region
a acceleration

1-10. (canceled)

11. A transmission for a drivetrain of a motor vehicle, the transmission comprising:
a transmission housing;
at least two drive elements in engagement with one another and accommodated in a housing interior of the transmission housing;
at least one displacement body configured to displace lubricant which is accommodated in the housing interior and used for lubricating the at least two drive elements; and
a lubricant exchange opening via which the lubricant can be exchanged between the housing interior and a peripheral region surrounding the housing interior;
wherein the at least one displacement body has at least one lubricant-guiding region configured to guide the lubricant, at least in some region or regions, along the displacement body and within the housing interior to the lubricant exchange opening.

12. The transmission as claimed in claim 11,
wherein the at least one displacement body is different from a machine element.

13. The transmission as claimed in claim 11,
wherein the displacement body occupies at least 20% of the housing interior.

14. The transmission as claimed in claim 13 wherein the displacement body occupies at least 40% of the housing interior.

15. The transmission as claimed in claim 14, wherein the displacement body occupies at least 60% of the housing interior.

16. The transmission as claimed in claim 11,
wherein the displacement body surrounds at least some region or regions of one of the drive elements.

17. The transmission as claimed in claim 11,
wherein the displacement body is a first displacement body, and wherein the transmission comprises at least one additional displacement body which is different from the first displacement body and surrounds at least some region or regions of at least one of the drive elements and the displacement body.

18. The transmission as claimed in claim 17,
wherein the first displacement body or the additional displacement body comprises at least one recess configured to receive at least some region or regions of at least one of the drive elements.

19. The transmission as claimed in claim 11 wherein the lubricant-guiding region comprises a through opening for guiding the lubricant or a groove for guiding the lubricant.

20. The transmission as claimed in claim 11, wherein the displacement body is formed from a nonmetallic material, in particular plastic.

21. The transmission as claimed in claim 11, wherein the transmission comprises a lubricant pump connected to the lubricant exchange opening and configured to extract lubricant from the housing interior.

22. A motor vehicle comprising:
a drivetrain with a drive motor; and
a transmission coupled to and configured to be driven by the drive motor, the transmission comprising:
a transmission housing;
at least two drive elements in engagement with one another and accommodated in a housing interior of the transmission housing;
at least one displacement body configured to displace lubricant which is accommodated in the housing interior and used for lubricating the at least two drive elements; and
a lubricant exchange opening via which the lubricant can be exchanged between the housing interior and a peripheral region surrounding the housing interior;
wherein the at least one displacement body has at least one lubricant-guiding region configured to guide the lubricant, at least in some region or regions, along the displacement body and within the housing interior to the lubricant exchange opening.

23. The motor vehicle as claimed in claim 22,
wherein the at least one displacement body is different from a machine element.

24. The motor vehicle as claimed in claim 22,
wherein the displacement body occupies at least 20% of the housing interior.

25. The motor vehicle as claimed in claim 22,
wherein the displacement body surrounds at least some region or regions of one of the drive elements.

26. The motor vehicle as claimed in claim 22,
wherein the displacement body is a first displacement body, and wherein the transmission comprises at least one additional displacement body which is different from the first displacement body and surrounds at least some region or regions of at least one of the drive elements and the displacement body.

27. The motor vehicle as claimed in claim 26,
wherein the first displacement body or the additional displacement body comprises at least one recess configured to receive at least some region or regions of at least one of the drive elements.

28. The motor vehicle as claimed in claim 22 wherein the lubricant-guiding region comprises a through opening for guiding the lubricant or a groove for guiding the lubricant.

29. The motor vehicle as claimed in claim 22,
wherein the displacement body is formed from a nonmetallic material, in particular plastic.

30. The motor vehicle as claimed in claim 22,
wherein the transmission comprises a lubricant pump connected to the lubricant exchange opening and configured to extract lubricant from the housing interior.
